(19) United States
(12) Patent Application Publication
(10) Pub. No.: US 2008/0263645 A1
(43) Pub. Date: Oct. 23, 2008

(54) PRIVACY IDENTIFIER REMEDIATION

(75) Inventors: Christopher K. Renter, Maple Ridge (CA); Denis A. Niles, North Vancouver (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: TELUS COMMUNICATIONS COMPANY, Burnaby (CA)

(21) Appl. No.: 11/739,031

(22) Filed: Apr. 23, 2007

(51) Int. Cl. H04L 9/32; G06F 17/00

(52) U.S. Cl. 726/6; 705/66; 726/12; 726/9

(57) ABSTRACT

A secure server installation is provided that abstracts credit card identifiers from its server, network, application and database environments, thus reducing investment in securing, segregating and/or isolating these environments in their entirety. The secure server installation intercepts credit card transactions sent from front end applications to back end applications, and forwards tokens in replacement of credit card identifiers for processing by the back end applications.

The same secure server installation can be applied for the encryption, storage (data-at-rest), transmission of private data within a network of other private or sensitive data not limited to social insurance numbers, drivers license numbers, phone numbers, bank account numbers, etc.

### BACKGROUND

As credit card fraud and identify fraud becomes more prevalent, credit card issuers and personal information providers (government agencies, etc) are requiring greater security by companies that process transactions using credit cards or other personal information. The software applications used by these companies must meet strict standards for credit card processing required by credit card issuers and personal information. The standards include providing secure processing and storage of credit card information, and other privacy identifiers such as driver's license, banking or other financial data as for example as may be achieved by suitable encryption of credit card identifiers, identification numbers or bank account numbers. However, it is very difficult for companies with existing credit card and other identifiable information (driver's license, social security numbers, banking information, etc) to meet these requirements.

### SUMMARY

A method and apparatus is provided for privacy identifier remediation using a secure server installation. The secure server installation abstracts privacy identifiers from its server, network, application and database environments, thus reducing investment in securing, segregating and/or isolating these environments in their entirety. The secure server installation intercepts transactions using privacy identifiers that are sent from front end applications to back end applications, and forwards tokens in replacement of privacy identifiers for processing by the back end applications. The secure server component also acts as a mediation gateway to connect to external agencies or processing systems. In an embodiment, the privacy identifiers comprise credit card numbers.

These and other aspects of the apparatus and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is schematic showing the processing components of an embodiment of a secure server installation and its environment;

FIG. 2 is flow diagram illustrating method steps of a privacy identifier remediation process;

FIG. 3 is a flow diagram illustrating further method steps of a privacy identifier remediation process;

FIG. 4 shows details of the process of FIG. 2 applied to the specific example of credit cards; and

FIG. 5 shows details of the process of FIG. 3 applied to the specific example of credit cards.

### DETAILED DESCRIPTION

In the claims, the word “comprising” is used in its inclusive sense and does not exclude other elements being present. The indefinite article “a” before a claim feature does not exclude more than one of the claim feature being present. Each one of the individual features described here may be used in one or more embodiments and is not, by virtue only of being described here, to be construed as essential to all embodiments as defined by the claims.

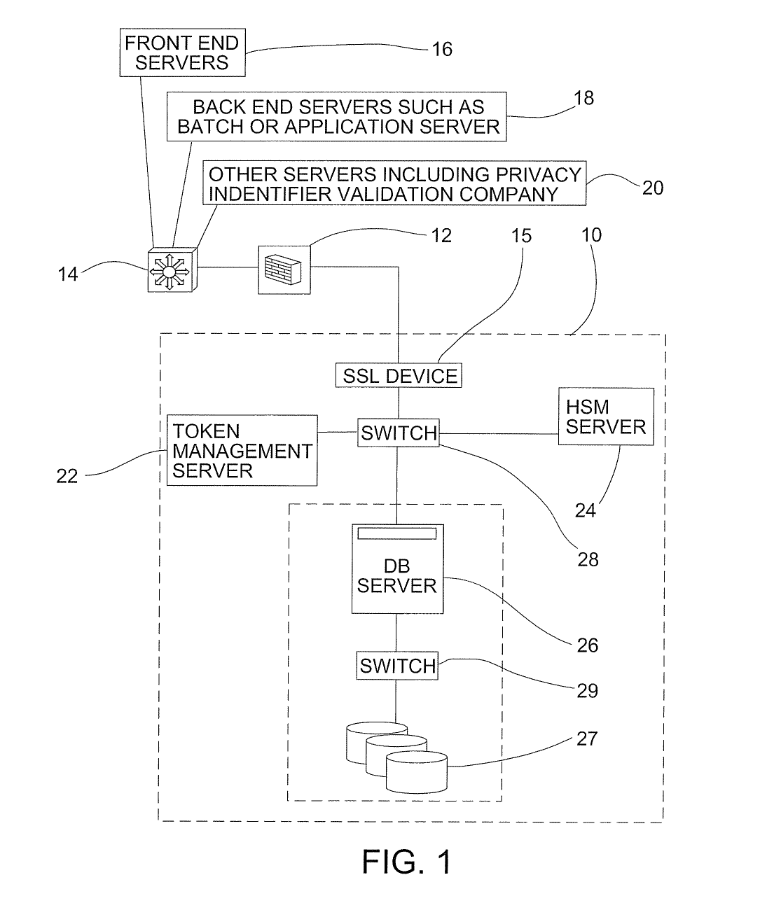

In FIG. 1, secure server installation 10 is physically isolated in a secure location and logically connected via firewall 12 and router 14 to a variety of front end servers 16, back end systems 18, systems 20 and external processing systems. The front end servers 16 comprise any server or device that captures one or more privacy identifiers such as credit card data, social insurance numbers, bank account numbers, driver's license numbers, contract numbers and phone numbers from a person such as a customer or consumer. The back end systems 18 comprise for example application and database servers that process privacy transactions, that is, a transaction that involves a privacy identifier. The systems 20 comprise privacy data validation servers, and may include for example end systems and users that need to connect to the secure server installation 10 for purposes of maintenance & operations, monitoring, logging of privacy data for purposes of audits, financial reporting and investigations. The connection links between the elements shown in FIG. 1 represent logical connections formed upon request over any communications link including optical fiber, wireless and wired connections, and may include intervening networks of any suitable kind such as portions of the internet. SSL or equivalent or better communications security should be used to secure communications, and for that purpose the secure server installation 10 may be connected via a firewall 12 to the router 14 by an SSL device 15 such as an SSL accelerator, as for example an SSL accelerator from F5 Networks.

The secure server installation 10 comprises in the embodiment shown a first server 22, referred to here for convenience as the Avalon server 22 (token management server), a second server 24, referred to here for convenience as the HSM server (hardware security module) and a third server 26, which acts as a database server. Other configurations of fewer or more servers could be used, and the entire functionality of the secure server installation in some embodiments could comprise a single server. The servers 22, 24 and 26 are connected together in this embodiment via multiple IP/Ethernet inter-connects in a bind configuration (for example an Ether-Channel) into a switch 28 such as a Cisco L2 or L3 switch. Database server 26 in this embodiment connects to a storage system, for example a disk array 27, via a suitable switch 29, such as a Brocade FC switch. Other arrangements may be used for storage, such as flash memory, tape or optical disk.

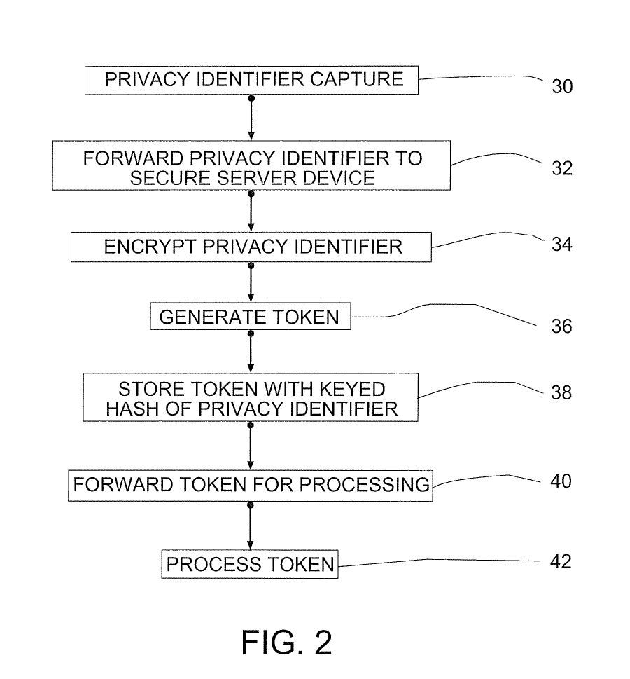

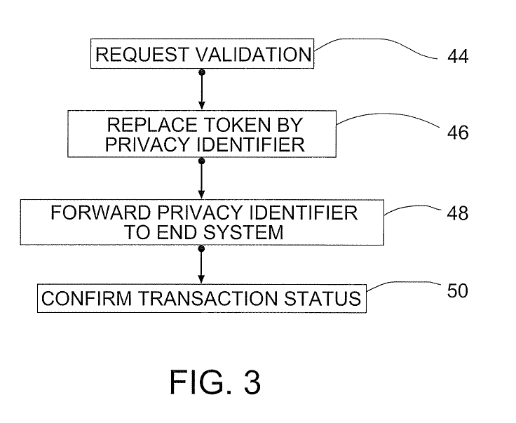

In operation, the system of FIG. 1 operates as follows according to the steps of FIG. 2 and 3. The process steps may be applied to any privacy identifier for example a credit card transaction, as for example when a customer seeks to purchase services using a credit card. As shown in FIG. 2, beginning with step 30, a front end server 16 captures a privacy identifier (PI) (as for example credit card data that may include a credit card identifier (CCI) and, in step 32, forwards the privacy identifier to the secure server installation 10. At the secure server installation, the privacy identifier is encrypted in step 34. In addition, a token uniquely associated with the privacy identifier is generated by an irreversible function in step 36. The token and encrypted privacy identifier and key hash of the privacy identifier are stored in a manner that they are associated with each other in step 38. The token is then forwarded to a back end server 18 in step 40 for further processing according to the nature of the transaction in step 42, where the token is processed as a proxy for the privacy identifier.

As shown in FIG. 3, the transaction may in some embodiments proceed as follows for the purpose of validating the privacy transaction, as for example a credit card validation where credit card data, and in some embodiments other privacy data, is validated. In step 44, the back end servers 18 request privacy identifier validation by generating a validation request message, and sending the validation request message to a information validation server 20 such as a credit card validation server. The validation request message contains the token and not the privacy identifier. At the secure server installation 10, the token is removed from the validation request message and replaced by the privacy identifier in step 46. In step 48, the validation request message is forwarded to an end system 20, such as a information validation server. Upon validation of the request, in step 50 a confirmation message is returned to the back end user 18 that requested validation. The privacy identifier (PI) is not included in the confirmation message to 18. If there is a privacy identifier (PI), it is removed by secure server installation 10.

As outlined below, in one exemplary embodiment applied to credit card identifiers, although similar operations may also be applied to other privacy identifiers, the Avalon server 22 is configured to generate unique and meaningless tokens, to request a search and match of tokens for association of correct credit card identifiers and an authentication code for the credit card identifiers via database server 26, to extract credit card identifiers and insert tokens for internal backend system processing and to extract tokens and insert credit card identifiers for external communications processing for payment validation.

A token is substituted for a privacy identifier for all back end transactions. The token is unique to the privacy identifier and meaningless in relation to the privacy identifier. That is, the privacy identifier cannot be determined from the token. One manner of accomplishing generation of a meaningless token is to select a length of characters by an irreversible function such as generating the token in sequential order as credit card identifiers are processed by the Avalon server 22. The token may thus be obtained by looking up an ordered sequence of tokens, and selecting an unused token from the ordered sequence. A suitably long token should be adopted to cover variable length privacy identifiers. The characters may include any suitable characters, such as numerals and letters but may include other characters.

In one embodiment, all tokens have a one-to-one relationship with privacy identifiers such as credit card numbers and other privacy identifiers. Thus, in the case where the privacy identifier is a credit card number, no matter how many times a customer issues a credit purchase with the same credit card identifier, the transactions may always use the same token that was issued the first time the customer completes a transaction using the secure server installation 10. The same applies to other privacy identifiers. If an individual provides the same ID for any number of financial transactions, the token associated with that ID will always be the same one utilized during the processing of the transaction.

By selecting a suitably long token, for example in one embodiment a numerical entity 21 digits long, there will never be more tokens issued to any particular individual than the total possible number of unique credit card identifiers and other privacy identifiers that an individual possesses and uses in the system. For example, as an extreme scenario, if an individual uses 40 different credit card identifiers and provides 40 pieces of different ID for various financial transactions, this individual would require a total of 80 unique tokens from the secure server installation 10. If we consider a total adult population of 500,000,000 (500 Million) for this scenario, the total number of tokens that the secure server installation would need to issue is 40,000,000,000 (40 Billion) tokens (80×500 Million). Thus, a token of length 21 digits will not be exhausted in practice. However, longer tokens could be used.

Tokens in one embodiment are issued in a sequential format for every request the system receives. Each request received however is completely random with no discernable pattern or ability to anticipate the type of value associated with the token. Token requests may come in from a variety of front end servers 16 and the generated token delivered to any of a large number of back end servers 18. The token requests may be processed in batches amongst other individual requests coming into the back end servers 18. Token requests may be associated with different types of identifiers (credit card verses other privacy identifiers), different credit card suppliers, different privacy identifiers (such as drivers license, bank account, PIN, Student Card, Government Employee #, etc. . . . ) and may be issued during any time of the day. Accordingly, due to the randomness, types of requests and data to be tokenized being sent to the secure server installation 10, it is quite impossible to define or construct a usable pattern of token issuing.

Request for tokens are restricted to specific applications whose authorization and authentication is tracked each time those applications need to communicate with the secure server installation 10. Once communication and access have been granted to the system, the activity to request a token, encryption/decryption or hashing service may be monitored, tracked and written to a log file. Tracking software may also be applied to the back end servers 18 which need to connect to the secure server installation 10. Thus there are multiple areas where processes are in place to ensure the secure request and issuing of tokens. The same security measures apply to those teams which need to access secure server installation 10 such as audit teams, reverse payment teams, system administrators and security officers. Thus only those systems and/or individuals with strict secure pre-defined credentials are able to request a credit card identifier for decryption by submitting a token. Each role of the audit teams, reverse payment teams, system administrators and security officers are granted specific levels of security without overlap of the other roles, further reducing risk.

Tokens are stored in the clear within the backend systems 18. If the token is sufficiently long, such as for example longer than any credit card or other privacy identifier, the token has no meaning that can be deduced from its length. In addition, even if the token was truncated, the specific format of the digits' numbering scheme would not meet the validation process of a credit card identifier. By generating the token from an irreversible function such as a sequential number generator, the token is completely independent of the credit card or privacy identifier randomly submitted by a particular person or business for the secure server installation 10 to process. Further, there is no association between the token and credit card identifier except for the token being the prime search key to find the encrypted credit card identifier which enables the completion of the requested financial transaction by a particular backend system 18. Additionally, this process is a one-way stream in which the back end system 18 cannot and does not see the privacy identifier when a transaction is processed. The secure server installation 10 is the last step in the communication stream between the back end servers 18 and external privacy identifier processing servers.

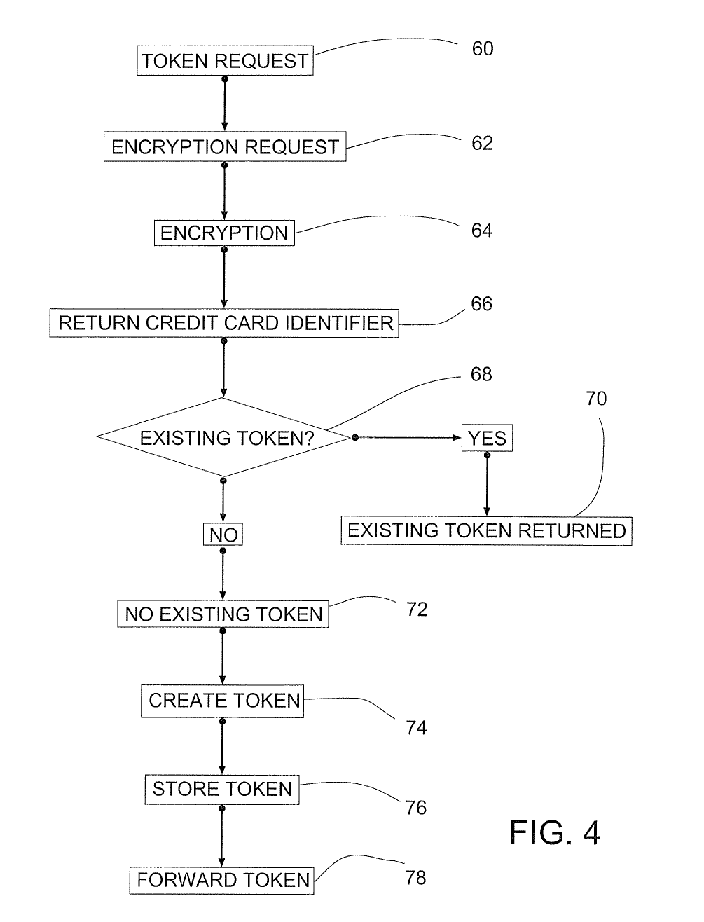

Referring to FIG. 4, further details of operation of a secure server installation are described in an exemplary embodiment applied to credit card transactions. The same process of token insertion and credit card identifier (CCI) encryption process may be applied to other privacy identifiers as for example bank account identifiers.

Step 60 Front End Server 16→Avalon Server 22 (Token Request) A process of credit card remediation begins with generation of a token request by a front end server 16 during a credit card processing request. The front end server 16 may be a web tier application that requires use of a credit card payment to complete a transaction. The front end server 16 will need to communicate with a back end server 18 for the purpose of completing the transaction. The normal transaction process using a credit card is commenced, but the front end server 16 pauses the transaction process for the time required to send the credit card identifier to the secure server installation 10 for a token request/receipt. Communication stream between the front end server 16 and secure server installation 10 is secured via SSL.

Step 62 Avalon Server 22→HSM Server 24 (Encryption Request) The Avalon server 22 at the secure server installation 10 receives credit card identifier and sends it to the HSM Server 24 for encryption and generation of the keyed hash of credit card identifier, for example by a KEYed Hash process.

Step 64 HSM (Encryption) The HSM server 24 encrypts the credit card identifier (using a strong encryption KEY #1 hash, as for example using a 1024 bit key) and builds an authentication code corresponding to the credit card identifier for look up purposes. The cryptography key for decryption is kept at the HSM server 24. An example of an authentication code is a keyed hash based on the credit card identifier+a 256 bit KEY (using Key #2) The strength of encryption KEY #1 and KEY #2 should be sufficiently strong to meet security standards applicable to the transaction process. An example authentication code is a keyed-hash message authentication code, or HMAC, calculated using a cryptographic hash function in combination with a secret key. As with any MAC, it may be used to simultaneously verify both the data integrity and the authenticity of a message. Any suitably strong iterative cryptographic hash function, such as MD5,SHA-1 or better, may be used in the calculation of an HMAC for this purpose. The cryptographic strength of the HMAC depends upon the cryptographic strength of the underlying hash function, on the size and quality of the key and the size of the hash output length in bits.

Step 66 HSM Server 24→Avalon Server 22 (Return CCI) The HSM server 24 returns the encrypted Credit card identifier and authentication code to the Avalon server 22.

Step 68 Avalon Server 22→Database Server 26 (Existing Token?) In an embodiment, before creating a token, the Avalon Server 22 sends the authentication code and, in some embodiments, an entity type to the database server 26 to search for an existing token. An entity type may be an additional security code based on a feature of the transaction being paused, as for example based on the credit card issuer (such as VISA™). Look up in the database server 26 is done via the authentication code and the entity type to lower or avoid the possibility of collisions (or token mismatch).

Step 70 Database Server 26→Avalon Server 22 (Existing token returned) If a match on authentication code and entity type is found, the database server 26 returns the token matched.

Step 72 Database Server 26→Avalon Server 22 (No existing token) If no match is found, the database server 26 returns a “null” response indicating to the Avalon server 22 that a new token must be created.

Step 74 Avalon server 22 (Create token). If no existing token is returned from the database server 26, the Avalon server 22 generates a new token as for example a unique sequential and meaningless number. The Avalon server 22 associates the token with an encrypted credit card identifier, the authentication code, and entity type, and also any other suitable identification information, such as a table name or key label, used by the database.

Step 76 Avalon server 22→Database Server (Store Token). In this step, the Avalon server 22 sends the token, encrypted credit card identifier, authentication code, entity type and other suitable identification information to the database server 26 for processing and storage. The database server 26 returns an acknowledge message when this process is complete.

Step 78 Avalon server 22→Back End Server 18 (Forward Token). Once an acknowledge response from the database server 26 has been received, the Avalon server 22 sends the token to the back end server 18, where the token is used by the back end server 18 to carry out the transaction requested by the front end server 16 that requested the transaction and originally forwarded the credit card identifier that has now been substituted by the token.

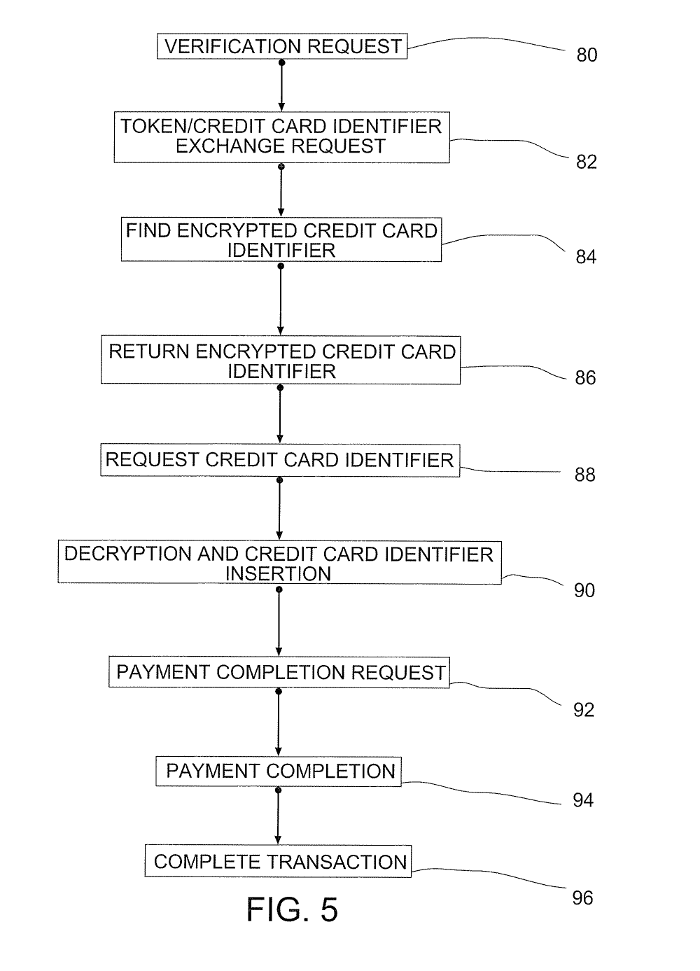

Referring to FIG. 5, steps 80-96 detail the payment confirmation process.

Step 80 Back End Server 18→Secure server installation 10 (Verification Request) If credit card verification is required, the following steps may be taken. Once the back end server 18 has completed its processing, the back end server 18 sends its financial transaction data stream (which includes the unique token) to the secure server installation 10 for credit card identifier lookup and re-insertion. Communication stream between the two entities is secured via SSL.

Step 82 Avalon server 22 (Token/CCI Exchange Request) The Avalon server 22 receives the data stream from the back end server 18 and pauses the transaction process for the time required to extract unique token, look up credit card identifier in the database 27 and re-insert credit card identifier in the data stream.

Step 84 Avalon server 22→Database Server 26 (Find encrypted CCI). Avalon server 22 sends the token to the database server 26 for encrypted credit card identifier look up.

Step 86 Database Server 26→Avalon server 22 (Return encrypted CCI) The database server 26 receives unique token, searches for matching token and associated encrypted credit card identifier. The database server 26 sends the encrypted credit card identifier to the Avalon server 22.

Step 88 Avalon server 22→HSM Server 24 (Request CCI). The Avalon server 22 receives the encrypted credit card identifier with the cryptography key label and sends it to the HSM server 24 for decryption.

Step 90 HSM Server 24→Avalon server 22 (Decryption and CCI Insertion) The HSM server 24 receives encrypted credit card identifier, decrypts and sends the decrypted CCI to the Avalon server 22. The Avalon server 22 receives decrypted credit card identifier and inserts into transaction stream in place of token.

Step 92 Avalon server 22→Private Information Validation Company 20 (Payment Completion Request, for example).The transaction stream from the back end server 18 with decrypted or real credit card identifier is sent to the Credit Card Validation Company 20 for payment process completion.

Step 94 Private Information Validation Company 20→Avalon server 22 (Payment Completion). The Private Information Validation Company 20 returns payment confirmation details to Avalon server 22. If the Private Information Validation Company 20 returns the private information identifier as part of its confirmation data to Avalon server 22, the private information identifier is stripped out prior to re-directing the completed transaction stream back to the back end server 18.

Step 96 Server 18→Front End Server 16 (Complete Transaction). The completed transaction with associated confirmation data is sent to the originating front end server 16. The transaction terminates where it originated from. A user could be a connected user to server 16 (a web browser for example).

The Avalon server 22 is configured for example using suitable software to generate unique & meaningless sequential numbers for variable field length credit card identifiers and privacy identifier fields. The tokens should thus have a sufficient number of digits to cover various length identifiers. While one type of encryption KEY may be used for the credit card identifier, other encryption keys may be used for other fields, such as privacy identifier fields, that require encryption. The Avalon server 22 may in some embodiments track, monitor, log and audit all activity relating to credit card processing done by the secure server installation 10. If separate servers 22, 24 and 26 are used, they should be clustered for reliability.

The HSM server 24 should be permitted to communicate only with the Avalon server 22 by suitable identification measures. In some embodiments, for strictest security, no device other than the Avalon server 22 should be able to issue requests to the HSM server 24. Some systems 20 may be permitted access to the Avalon server 22 for purposes of maintenance, operations, audits and investigations.

The HSM Server 26 provides encryption, decryption, authentication code, keyed hash generation and key management for the secure server installation 10.

Immaterial modifications may be made to the embodiments described here without departing from what is covered by the claims.

What is claimed is:

1. A method of privacy identifier remediation, comprising the steps of:
capturing a privacy identifier at a front end server;
forwarding the privacy identifier to a secure server installation;
at the secure server installation, obtaining a token to replace the privacy identifier, the token being unique and meaningless in relation to the privacy identifier;
forwarding the token from the secure server installation to a back end server; and
processing the token as a proxy for the privacy identifier at the back end server.

2. The method of claim 1 in which obtaining the token comprises:
checking for a pre-existing token corresponding to the privacy identifier;
if there is a pre-existing token corresponding to the privacy identifier, then forwarding the pre-existing token in replacement of the privacy identifier; and
if there is no pre-existing token corresponding to the privacy identifier, then generating a token and forwarding the generated token in replacement of the privacy identifier.

3. The method of claim 2 in which:
generating a token is carried out in a token management server; and
pre-existing tokens are stored in a storage medium managed by a database server.

4. The method of claim 2 in which generating the token comprises looking up an ordered sequence of tokens and selecting an unused token from the ordered sequence of tokens.

5. The method of claim 1 further comprising:
requesting private information identifier validation by generating a validation request message for sending to a private information validation server, the validation request message containing the token;
at the secure server installation, replacing the token in the validation request message by the private information identifier; and
forwarding the validation request message to the private information validation server.

6. The method of claim 1 further comprising the step of:
encrypting the privacy identifier at the secure server installation to generate an encrypted privacy identifier with a keyed hash the privacy identifier; and
associating the token with the encrypted privacy identifier.

7. The method of claim 6 in which:
encrypting the privacy identifier is carried out at a secure encryption server; and
associating the token with the encrypted privacy identifier is carried out at a token management server.

8. The method of claim 7 in which obtaining the token comprises:
checking for a pre-existing token corresponding to the privacy identifier with the search of the keyed hash of the privacy identifier;
if there is a pre-existing token corresponding to the privacy identifier, then forwarding the pre-existing token in replacement of the privacy identifier; and
if there is no pre-existing token corresponding to the privacy identifier, then generating a token and forwarding the generated token in replacement of the privacy identifier.

9. The method of claim 8 in which:
generating a token is carried out in the token management server; and
pre-existing tokens are stored in a storage medium managed by a database server.

10. The method of claim 9 in which generating the token comprises looking up an ordered sequence of tokens and selecting an unused token from the ordered sequence of tokens.

11. The method of claim 10 further comprising:
requesting privacy identifier validation by generating a validation request message for sending to a private information validation server, the validation request message containing the token;
at the secure server installation, replacing the token in the validation request message by the privacy identifier; and
forwarding the validation request message to the private information validation server.

12. The process of claim 1 in which the privacy identifier comprises a credit card number.

13. Apparatus configured to carry out the steps of method claim 1.

14. A method of privacy identifier remediation, comprising the steps of:
capturing a privacy identifier at a front end server;
forwarding the privacy identifier to a secure server installation;
at the secure server installation, encrypting the privacy identifier to generate an encrypted privacy identifier with the keyed hash of the privacy identifier, generating a token uniquely associated with the privacy identifier, the token being meaningless in relation to the privacy identifier and storing the token and encrypted privacy identifier;
forwarding the token to a back end server; and
processing the token as a proxy for the privacy identifier at the back end server.

15. The method of claim 14 further comprising the steps of:
requesting privacy identifier validation by generating a validation request message for sending to a private information validation server, the validation request message containing the token;
at the secure server installation, replacing the token in the validation request message by the privacy identifier; and
forwarding the validation request message to the private information validation server.

16. The method of claim 15 further comprising confirming transaction completion after validation of the privacy identifier at the privacy validation server.

17. The method of claim 16 in which the privacy identifier comprises a credit card number.

18. A method of credit card identifier remediation, comprising the steps of:
receiving a credit card processing request, the request containing a credit card identifier;
obtaining a token to replace the credit card identifier, the token being unique and meaningless in relation to the credit card identifier; and
forwarding the token for processing as a proxy for the credit card identifier.

19. The method of claim 18 in which obtaining the token comprises:
checking for a pre-existing token corresponding to the credit card identifier;
if there is a pre-existing token corresponding to the credit card identifier, then forwarding the pre-existing token in replacement of the credit card identifier; and
if there is no pre-existing token corresponding to the credit card identifier, then generating a token and forwarding the generated token in replacement of the credit card identifier.

20. The method of claim 19 in which checking for a pre-existing token is carried out by searching for a keyed hash of the credit card identifier associated with the token.

21. The method of claim 19 in which:
generating a token is carried out in a token management server; and
pre-existing tokens are stored in a storage medium managed by a database server.

22. The method of claim 18 in which obtaining the token comprises looking up an ordered sequence of tokens and selecting an unused token from the ordered sequence of tokens.

23. The method of claim 18 further comprising the step of:
encrypting the credit card identifier to generate an encrypted credit card identifier; and
associating the token with the encrypted credit card identifier.

24. The method of claim 23 in which:
encrypting the credit card and the keyed hash of the credit card identifier is carried out at a secure encryption server; and
associating the token with the encrypted credit card identifier is carried out at a token management server.

25. The method of claim 24 in which obtaining the token comprises:
checking for a pre-existing token corresponding to the credit card identifier;
if there is a pre-existing token corresponding to the credit card identifier, then forwarding the pre-existing token in replacement of the credit card identifier; and
if there is no pre-existing token corresponding to the credit card identifier, then generating a token and forwarding the generated token in replacement of the credit card identifier.

26. The method of claim 25 in which checking for a pre-existing token is carried out by searching for a keyed hash of the credit card identifier associated with the token

27. The method of claim 26 in which:
generating a token is carried out in the token management server; and
pre-existing tokens are stored in a storage medium managed by a database server.

28. The method of claim 27 in which generating the token comprises looking up an ordered sequence of tokens and selecting an unused token from the ordered sequence of tokens.

29. Apparatus configured to carry out the steps of method claim 18.

30. A secure server installation, comprising:
one or more servers connected via a firewall to a network router; and
the one or more servers being configured to:
receive a privacy processing request, the request containing a privacy identifier;
encrypting the privacy identifier for safe storage of the encrypted privacy identifier, the encrypted privacy identifier being encrypted with a key for decryption;
obtain a token to replace the privacy identifier, the token being unique and meaningless in relation to the privacy identifier; and
forward the token for processing as a proxy for the privacy identifier.

31. The secure server installation of claim 30 in which the one or more servers comprise:
a secure encryption server for carrying out encryption and decryption functions; and
a token management server for coordinating selection of a token.

32. The secure server installation of claim 31 in which the one or more servers comprise a database server for managing storage of tokens and encrypted privacy identifiers.
